(19) United States
(12) Patent Application Publication
(10) Pub. No.: US 2015/0269953 A1
(43) Pub. Date: Sep. 24, 2015

(54) AUDIO SIGNAL MANIPULATION FOR SPEECH ENHANCEMENT BEFORE SOUND REPRODUCTION

(71) Applicant: Audiologicall, Ltd., London (GB)

(72) Inventor: Mehdi Siami, London (GB)

(21) Appl. No.: 14/686,531

(22) Filed: Apr. 14, 2015

Related U.S. Application Data
(63) Continuation of application No. PCT/US13/65329, filed on Oct. 16, 2013.
(60) Provisional application No. 61/714,670, filed on Oct. 16, 2012.

(51) Int. Cl. G10L 21/02

(52) U.S. Cl. CPC G10L 21/02

(57) ABSTRACT

Disclosed herein is a system and method for processing sound data, the method comprising identifying a user speech enhancement profile of a user to whom the sound data is intended for listening; processing the sound data with the identified user speech enhancement profile at a speech enhancement computer processor and producing a manipulated sound output; and providing the manipulated sound output to the user

### CROSS-REFERENCE TO RELATED APPLICATIONS

This application is a continuation of International Application No. PCT/US13/65329, filed Oct. 16, 2013 which claims priority to U.S. Provisional Application Ser. No. 61/714,670 filed Oct. 16, 2012 to inventor Mehdi Siami, entitled “Sound Modulation for Telephony”, which are both hereby expressly incorporated by reference in their entirety for all purposes.

### BACKGROUND

We live in a sound-centric world and hearing loss has a profound impact on the lives of many people. Current estimates are that over 20% of populations have some hearing loss and over 10% have “disabling” hearing loss.

It is commonly acknowledged that most of the hearing impaired do not have a hearing aid. Typically cited statistics suggest as many as 80% of Hearing Impaired in developed economies, and 98% in developing economies, are lacking needed hearing aids. In developed economies, stigma can play a big part, as even when hearing aids are available at no cost, e.g. in the UK, still the majority of the hearing impaired, 60%, do not seek to get a hearing aid.

A significant problem for this group occurs in the absence of visual signals, i.e. during non-face-to-face communications.

Even in those populations that do have hearing aids, some evaluations indicate that 75% do not wear them more than 8 hours per day, 25% never wear the Hearing Aid at all.

One reason for this lack of usage of Hearing Aids, is dissatisfaction from the effectiveness of Hearing Aids in a variety of real life situations that the current Hearing Aid algorithms are not optimized for.

Hearing Aid algorithms have improved greatly, but most are still developed from a “system” perspective, i.e., from an understanding of physiology of hearing and usually only tested in laboratory environment with a small sample. This leads to algorithms that are effective for most situations similar to that tested, but not as effective at many other real-life environments.

There is a need for devices that provide improved intelligibility for a user's hearing loss in a wide variety of environments. Disclosed herein are techniques for satisfying that need.

### SUMMARY

Disclosed herein is a system and method for processing sound data, the method comprising identifying a User Speech Enhancement Profile of a user to whom the sound data is intended for listening; processing the sound data with the identified user speech enhancement profile at a speech enhancement computer processor and producing a manipulated sound output; and providing more intelligible speech output to the user.

Described herein is a solution for the Hearing Impaired to make reproduced sound more intelligible without the need for Hearing Aids, particularly in telephony, conference calls, radio broadcasts, podcasts, and the like.

Other features and advantages of the present invention should be apparent from the following description of exemplary embodiments, which illustrate, by way of example, aspects of the invention.

### BRIEF DESCRIPTION OF THE DRAWINGS

FIG. 1 is a block diagram that illustrates conventional hearing aid technology as currently used with telephony systems.

FIG. 2 is a block diagram that illustrates a system that utilizes the teachings described herein.

FIG. 3 is a block diagram that illustrates an arrangement of the FIG. 2 system to divert any type of telephony call via the telephony system described herein.

FIG. 4 is a block diagram that illustrates an arrangement of the FIG. 2 system to set up and update profiles of the user, including user call management preferences.

FIG. 5 is a flow diagram that illustrates operation of the FIG. 2 system to perform a setup function using a remote technique.

FIG. 6 is a flow diagram that illustrates operation of the FIG. 2 system to perform a setup function using an online technique.

FIG. 7 is a flow diagram that illustrates operation of the FIG. 2 system to perform a setup function using a third party system.

FIG. 8 is a flow diagram that illustrates operation of the FIG. 2 system to perform a setup function using application software.

FIG. 9 is a flow diagram that illustrates operation of the FIG. 2 system to perform a setup function using a conventional telephone.

FIG. 10 is a flow diagram that illustrates operation of the FIG. 2 system to perform a setup function using generic profiles.

FIG. 11 is a flow diagram that illustrates operation of the FIG. 2 system to perform a setup function using updates and additional techniques.

FIG. 12 is a flow diagram that illustrates making calls in the FIG. 2 system from any telephone with User ID and PIN.

FIG. 13 is a flow diagram that illustrates making calls in the FIG. 2 system from registered phone numbers without User ID.

FIG. 14 is a flow diagram that illustrates making calls in the FIG. 2 system with a plug-in call diverter without access number.

FIG. 15 is a flow diagram that illustrates making calls in the FIG. 2 system with an analog telephone adaptor.

FIG. 16 is a flow diagram that illustrates making calls in the FIG. 2 system from a smartphone with a dialer application without an access number.

FIG. 17 is a flow diagram that illustrates making calls in the FIG. 2 system from an IP phone or with IP phone software.

FIG. 18 is a flow diagram that illustrates receiving calls in the FIG. 2 system using a “Follow me” service or virtual telephone number or an IP phone.

FIG. 19 is a flow diagram that illustrates operations of the FIG. 2 system during a telephone call.

FIG. 20 is a block diagram that illustrates an embodiment of the DSE system described herein.

FIG. 21 is a block diagram that illustrates operation of the FIG. 20 system during sound processing.

FIG. 22 is a block diagram that illustrates operation of the FIG. 20 system after completion of sound processing.

FIG. 23 is a block diagram that illustrates improved sound processing features provided by the FIG. 20 system.

FIG. 24 is a dashboard design according to one embodiment.

### DETAILED DESCRIPTION

For conventional hearing aids, most sound signal processing in the hearing aid is indiscriminate. That is, Hearing Aid signal processing may be bespoke to an individual, but it is not bespoke to type of sound nor environment of listener; none are developed dynamically from usage data.

Devices transmitting or reproducing sound signals frequently include sound filters or codecs to reduce cost of data transmission and storage, or improve sound quality. The algorithms for these sound filters are fixed and they are applied indiscriminately to all the sound signals being processed in the same way, regardless of the listener or characteristics of the sound being processed.

Hearing aids and assistive devices perform signal manipulation to improve the sound quality, but to parameters set according to the hearing loss profile of a specific user. These parameters are typically set during fitting of the hearing aid. The algorithms and settings are limited by the compromise of attempting to be most effective on typical types of sound to be processed, in the most common environments users will find themselves in. This makes the signal manipulation in these devices less effective in many less common environments.

The algorithms for hearing aids are typically developed from a systems perspective based on anatomy and physiology of the human hearing system and the nature of the impairment, then validated with a small group of listeners in a laboratory environment under synthetic control conditions usually with limited standardized pre-recorded background noises and sound files.

What is New

Table 1 below is a summary of novel features provided by the system and processing described herein. In Table 1, the features and operation of system and processing described herein is listed under the column “DSE”, an abbreviation of “Dynamic Speech Enhancement”, comprising the novel system and processing described herein. The left column has a heading “Existing Sound Signal Manipulation” with some characteristics of conventional systems. The right column has a heading “DSE” with characteristics of the system described herein that provide improvements over corresponding left-side entries in Table 1.

TABLE 1
Table 1.

| Existing Sound Signal Manipulation | DSE |
|---|---|
| Sound signal processing is common | DSE can provide bespoke sound |
| in telecom and electronic devises, | signal manipulation for Speech |
| but only bespoke sound manipulation | Enhancement in telecom and |
| to a listener profile available in | electronic devices and software |
| Hearing Aids. | applications, not just hearing aids. |
| Even sound signal manipulation that | DSE can provide sound signal |
| is bespoke to individual listener | manipulation, also bespoke to any |
| i.e. in hearing aids, is not bespoke | characteristics of sound being |
| to characteristics of sound or | processed (e.g. noisy signal, |
| environment of the listener. | language being spoken, speed of |
| | speaker etc.), and any environment |
| | of the listener (e.g. car, busy |
| | office etc.) |
| Sound signal processing algorithms | DSE algorithms can be customized |
| used in hearing aids are optimized | for any combination of devices |
| and fixed for the hearing aid device | receiving, transmitting and |
| receiving and reproducing the | reproducing the sound for the user. |
| corrected sound for the user. | (e.g. different phones, carrier, |
| | headphone, speaker etc.) |
| Sound signal processing parameters | DSE algorithm and settings can be |
| once set, do not change in response | changed automatically or manually |
| to changes to the user's condition | to be best suited for the |
| or environment, nor characteristics | characteristics of sound being |
| of sound being processed. | processed or the user's |
| | environment or condition (e.g. |
| | tired). |
| The algorithms for typical sound | DSE algorithms are developed and |
| signal processing are developed from | improved from a data perspective, |
| a ‘system’ perspective and tested | incorporating machine-learning |
| to confirm effectiveness. | systems to continually improve |
| | Speech Enhancement and respond |
| | to changes. |

DSE In Telephony and/or Electronic Devices

Hearing aids are wearable instruments that typically fit in or behind the wearer's ear. As used herein, “raw” sound is sound that is delivered to the hearing aid via a microphone on the instrument or wirelessly, e.g. via Bluetooth, and only then is the sound signal manipulated by the electronics within the hearing aid. The parameters of the signal processing algorithms are pre-set during fitting according the hearing loss profile of the wearer. The hearing loss profile is typically determined by a medical professional using auditory testing techniques, as known to those skilled in the art. If the wearer is not happy with the sound correction, they typically have to return to the medical professional to alter the pre-set parameters of the signal processing algorithms used by the hearing aid.

The system described herein includes a machine for and method of manipulating sound data before it is transmitted from a sound producing device. The method may be characterized as comprising: receiving the sound data from a sound producing device at a signal processing computer processor; producing manipulated speech signal output; settings to the signal processing algorithm based on applying the user hearing loss profile settings to the received sound data; and providing the manipulated sound output to the user from the sound producing device.

This technique of manipulating the sound before it leaves a sound producing device allows the user to listen to the enhanced speech sound without the use of a conventional hearing aid.

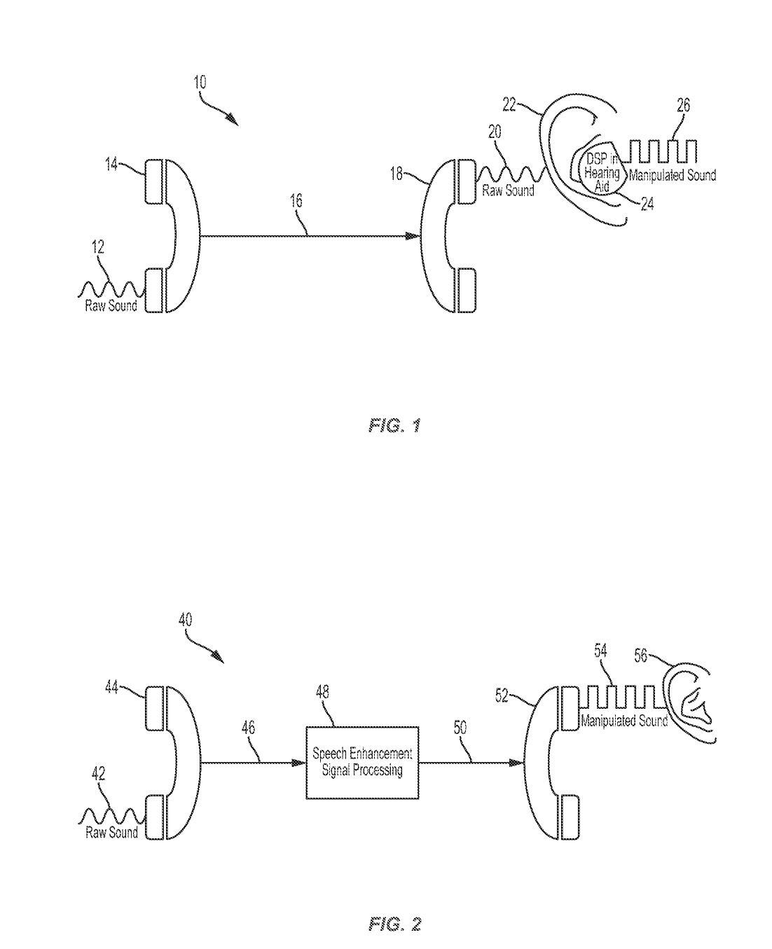

FIG. 1 illustrates the current hearing aid technology when used with telephony. Raw Sound (12) is received at the microphone of a telephone (14) and converted to an electronic signal and transmitted by a variety of means (16) to a receiving telephone (18), where it is converted back to sound by its loudspeaker. This raw sound thus produced (20) is received by a conventional hearing aid (24), usually via a microphone, and is converted to an electronic sound signal. The sound signal is then processed by the electronics inside the hearing aid (24). The processed sound signal comprises manipulated sound (26) that is reproduced by the hearing aid loudspeakers and directed into the ear of the hearing aid user (22).

FIG. 2 illustrates an embodiment in which novel features disclosed herein are applied to telephony. The description for FIG. 2 presumes that the exemplary call involves a speaking person at a first sound device or telephone (44) and a listening (receiving) person at a second sound device or telephone (52), but it should be understood that the situation could also apply in reverse; that is, the person at the second telephone (52) may speak to the person at the first telephone (44), with the processing described in this explanation being reversed to produce the manipulated sound data generated by the person speaking.

In FIG. 2, Raw Sound (42) is received at a sound collection component such as the microphone of a telephone (44) and converted to an electronic signal and transmitted by a variety of means (46) to the Dynamic Speech Enhancement System (48). The variety of means (46) may include, for example, wired connection, wireless connection, and/or a combination of the two. The Speech Enhancement System (48) performs processing to manipulate the sound data collected at the sound collection component in accordance with a profile of the user to whom the call is directed, that is, a profile at the user at the second telephone (52). That is, the Dynamic Speech Enhancement System is external to the first telephone (44) and the second telephone (52). The Dynamic Speech Enhancement System (48) may comprise a computer processor that performs computer operations or processing to the sound data and produce Manipulated Sound data (54). The Manipulated Sound Signal is transmitted by a variety of means (50) to a receiving telephone (52), where it is converted to sound by a sound reproduction component of the second telephone (52), such as its loudspeaker. The variety of means (50) may include, for example, wired connection, wireless connection, and/or a combination of the two.

At the second telephone (52), the Manipulated Sound (54) is produced and directed into the ear of the listener (56). With the speech signal already manipulated by the Dynamic Speech Enhancement system (48), a hearing impaired user no longer requires a hearing aid to increase the intelligibility of the sound. Thus, after the user at the first telephone (44) speaks, the sound data produced from the first telephone (44) is processed based on the user profile of the user at the second telephone (52) such that the user at the second telephone (52) may listen to the manipulated sound data without use of a hearing assistance device that the user at the second telephone would otherwise need to use, and in the absence of which the user would be unable to hear the sound data as intelligibly. Such a person would typically depend on, for example, a hearing aid for clear listening. The Dynamic Speech Enhancement System (48) may be placed at any location in the sound data transmission path between the sound collection component of the first telephone (44) and the sound reproduction component of the second telephone (52), and vice versa. As noted above, the user at the second telephone (52) may speak into the telephone for listening by the user at the first telephone (44) and, if the first user has a user profile, the sound data of the second user may be corrected based on the user profile of the first user. That is, the telephone handset equipment is generally symmetric, for example, the first telephone (44) and second telephone (52) each have a sound collection component and a sound reproduction component. The computer processor of the Dynamic Speech Enhancement System (48) has sufficient resources and capabilities for performing the processing functions described herein. For example, the computer processor may be implemented as a conventional laptop computer, personal computer, server computer or the like, having a processor unit, input/output components, network interface, display, data storage, memory, and the like, typically communicating over a system bus of the Dynamic Speech Enhancement System computer processor.

Although the description above is provided in the context of telephony, it should be understood that the features described above could be applied in other embodiments such as consumer electronics, mobile sound devices, and sound reproduction devices generally. Such other embodiments may be implemented in sound devices such as mobile music players, televisions, mobile computing devices, and the like, such that the respective devices are capable of manipulating the sound data before the sound data leaves the device, enabling listening by a user without aid of a hearing assistance device, in the absence of which the user would be unable to hear the sound data as intelligibly. In such situations, the sound collection component (first sound device) of FIG. 2 would correspond to a sound source, such as pre-recorded music tracks, and the second sound device would correspond to a loudspeaker or other audio output of the second sound device. That is, the user would be enabled to listen to output of the second sound device, comprising the sound data, without aid of a hearing assistance device, in the absence of which the user would be unable to hear the sound data as intelligibly.

Dynamic Speech Enhancement (DSE) in Telephony

Described herein is an “Dynamic Speech Enhancement” (DSE) for telephony, in which raw sound data is diverted via a telephony network comprising an exchange or the Internet to a DSE System for the sound data to be manipulated according to the user's profile. The manipulated sound is then diverted back through the telephony network to be received by any standard telephone, VOIP phone, computer interface, or other telephony device, already manipulated to the hearing profile selected by or for the user to provide Speech Enhancement.

Receiving DSE Telephony calls is typically provided via a “follow me” or Virtual phone number service to deliver the DSE Telephony calls to any standard telephone equipment, VOIP interface or other telephony device being used to receive the call.

Making DSE Telephony calls is typically provided from any standard telephone or VOIP interface or other telephony device via an access number to divert the call via the DSE Telephony system to be processed. As an alternative to access numbers, plug-in switches or software applications can be used to automatically route all calls via the DSE Telephony system.

Alternatively users can have all their calls routed through the DSE Telephony system. To have all their cell phone calls they get a new SIM and number or port their number, for all their land line calls, they transfer their account to an DSE service provider and get a new number, or port their existing number to the DSE service provider.

For each service subscriber or user of the DSE service, the DSE service offers setting up of DSE Profiles that can be set up for different situations and types of equipment being used: e.g., profiles for: cell phone, land line, conference call, quiet location, busy location, cell phone in busy location, land line in quite location, and the like. Each profile is associated with a set of parameters that determine the audio signal manipulation algorithm to which speech signal is subjected.

DSE Profiles can be automatically applied depending on the phone number being used or called or other data such as the sound characteristics of the voice call. Sound characteristics of the incoming audio signal that could be used would be those that are indicative of the level and type of background noise, the language being spoken, the speed of speech or any other characteristic that can impact intelligibility of the speech for the listener. Alternatively, Profiles can be manually switched on/toggled during the call, or turned off completely.

DSE Profiles can be created from third party Hearing Tests sent or uploaded to the service, or created via software applications on smart-phones or computers or other devices; or via manual or automated hearing test carried out over the phone; or selected from a set of standard profiles, or by other suitable means known to those skilled in the art.

The DSE System evaluates the characteristics of the incoming and outgoing sound signals to select the parameters for the Signal Manipulation Algorithms. Parameters will be set based on the User's DSE profile, the devices being used, and the characteristic of incoming sound to be processed that can effect intelligibility i.e. level and type of background noise, language being spoken, gender and age of the speaker etc.

The effectiveness of the DSE system to produce more intelligible and comfortable corrected signal will be monitored by evaluating the ‘characteristics’ of the outgoing sound signals, and/or by feedback and scoring by the user or other human listeners.

The effectiveness of the manipulated sound signal, evaluated in this way, informs the machine learning systems of the DSE system to continuously improve the algorithms for setting the parameters for the Audio Signal Manipulation Module.

For clarity the following descriptions are limited to telephone calls between a DSE user and a non-user i.e. one way speech enhancement; but the method is equally applicable for DSE to DSE telephony, or multiple DSE users in a conference call, or any other permutation thereof.

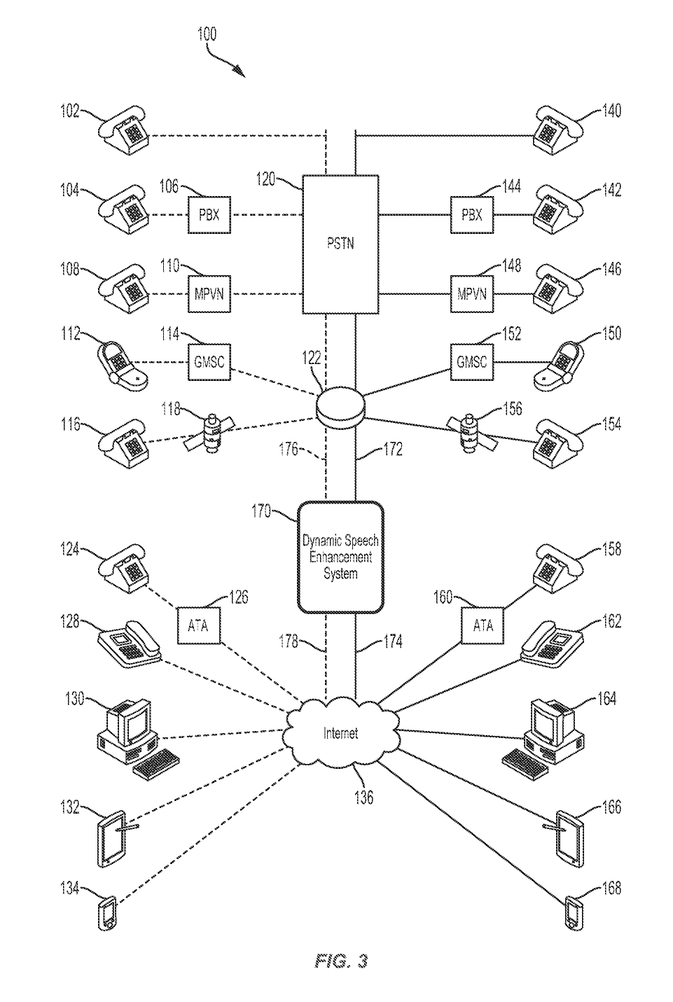

FIG. 3, including references (100) to (178), illustrates a typical arrangement of the system to divert any type of telephony call via the DSE Telephony system to be manipulated according to the user's preferences before being diverted to their device. The reference numerals in FIG. 3 correspond as follows:
100 A typical arrangement of the system to be used to divert any type of telephony call via the DSE Telephony system to be manipulated according to the user's preferences before being forwarded to their device.
102 Conventional Telephone or equivalent.
104 Conventional Telephone or equivalent in a private branch exchange (PBX) or equivalent
106 Private branch exchange (PBX) or equivalent
108 Conventional Telephone or equivalent on a ‘managed facilities-based voice network’ (MFVN) or equivalent; such as those provided by cable companies.
110 Managed facilities-based voice network (MFVN) or equivalent; such as those provided by cable companies
112 Cell Phone or equivalent
114 Gateway mobile switching center or equivalent
116 Satellite Phone or equivalent
118 Satellite or equivalent
120 Public switched telephone network (PSTN) or equivalent
122 Telephone Switch or equivalent
124 Conventional Telephone or equivalent connected to internet via an analog telephone adaptor (ATA) or equivalent.
126 Analog telephone adaptor (ATA) or equivalent.
128 IP Phone or equivalent.
130 Computer with VoIP or Softphone or other Telephony application software.
132 Tablet computer or equivalent with VoIP or other Telephony application software.
134 Smartphone or equivalent with VoIP or other Telephony application software.
136 Internet
140 Conventional Telephone or equivalent
142 Conventional Telephone or equivalent in a private branch exchange (PBX) or equivalent
144 Private branch exchange (PBX) or equivalent
146 Conventional Telephone or equivalent on a managed facilities-based voice network (MFVN) or equivalent; such as those provided by cable companies
148 Managed facilities-based voice network (MFVN) or equivalent; such as those provided by cable companies
150 Cell Phone or equivalent
152 Gateway mobile switching center or equivalent
154 Satellite Phone or equivalent
156 Satellite or equivalent
158 Conventional Telephone or equivalent connected to internet via an analog telephone adaptor (ATA) or equivalent.
160 Analog telephone adaptor (ATA) or equivalent.
162 IP Phone or equivalent.
164 Computer with VoIP or Softphone or other Telephony application software.
166 Tablet computer or equivalent with VoIP or other Telephony application software.
168 Smartphone or equivalent with VoIP or other Telephony application software.
170 DSE Telephony Service: A method of processing Audio Signal, the method comprising: receiving the Audio Signal at a Speech Enhancement computer processor; identifying a User Speech Enhancement profile of a user to whom the Audio Signal is intended for listening; producing a manipulated audio output based on applying the User Speech Enhancement profile to the received Audio Signal; providing the Enhanced Speech output to the user.
172 ‘Raw’ or un-manipulated sound routed to the DSE Telephony Service
174 ‘Raw’ or un-manipulated sound routed to the DSE Telephony Service
176 Manipulated sound routed from the DSE Telephony Service
178 Manipulated sound routed from the DSE Telephony Service

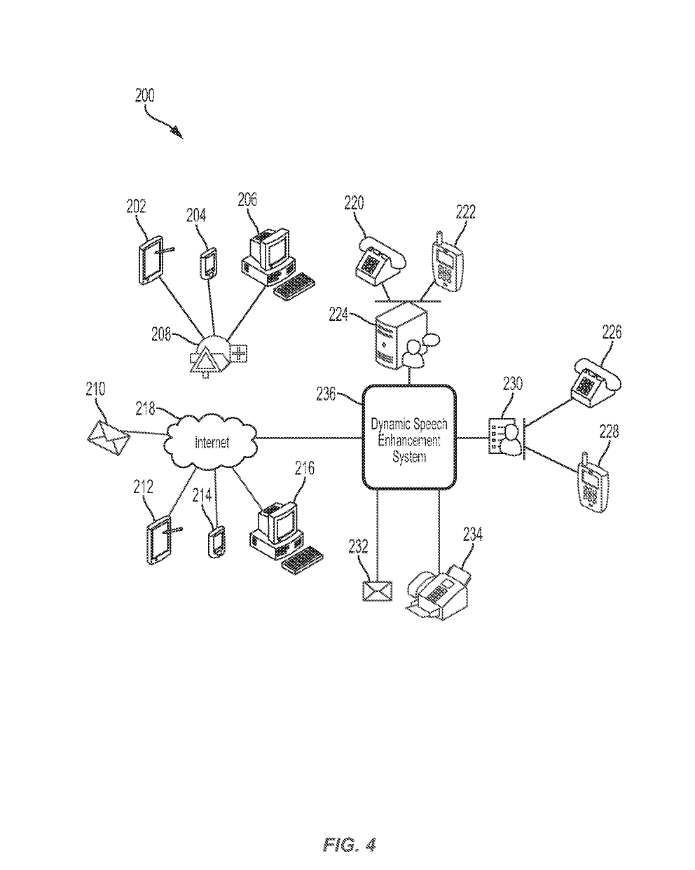

FIG. 4, including reference numerals (200) to (236), illustrates a typical arrangement of the system used to set up and update the user's DSE Telephony Profiles and call management preferences.
200 Typical arrangement of the system used to set up and update the user's DSE Telephony Profiles and call management preferences
202 Tablet computer or equivalent
204 Smartphone or equivalent
206 Computer or equivalent
208 Web page or web based application or equivalent interface to set up and/or update user's profiles and preferences.
210 Electronic transmission or email or equivalent containing information and any attachments to set up and/or update user's profiles and preferences.
212 Tablet computer or equivalent with application software to set up and/or update user's profiles and preferences. For example could be part of telephony software or stand-alone application.
214 Smartphone or equivalent with application software to set up and/or update user's profiles and preferences. For example could be part of telephony software or stand-alone application.
216 Computer or equivalent with application software to set up and/or update user's profiles and preferences. For example could be part of hearing test software or stand-alone application.
218 Internet
220 Conventional Phone or equivalent
222 Cell phone or equivalent
224 Speech Server or equivalent with Interactive Voice Response (IVR) facility and/or Dual-Tone Multi-Frequency signalling (DTMF) facility or other automated facility to set up and/or update user's profiles and preferences.
226 Conventional Phone or equivalent
228 Cell phone or equivalent
230 A live operator to set up and/or update user's profiles and preferences.
232 Physical documents and/or physical data storage devices such as CDs presented containing information to set up and/or update user's profiles and preferences.
234 Fax machine, modem or other transmission system for submitting information to set up and/or update user's profiles and preferences.
236 DSE Telephony Service: A method of processing Audio Signal, the method comprising: receiving the Audio Signal at a Speech Enhancement computer processor; identifying a User Speech Enhancement profile of a user to whom the Audio Signal is intended for listening; producing a manipulated audio output based on applying the User Speech Enhancement profile to the received Audio Signal; providing the Enhanced Speech output to the user.

Dynamic Speech Enhancement (DSE) Telephony—Processes

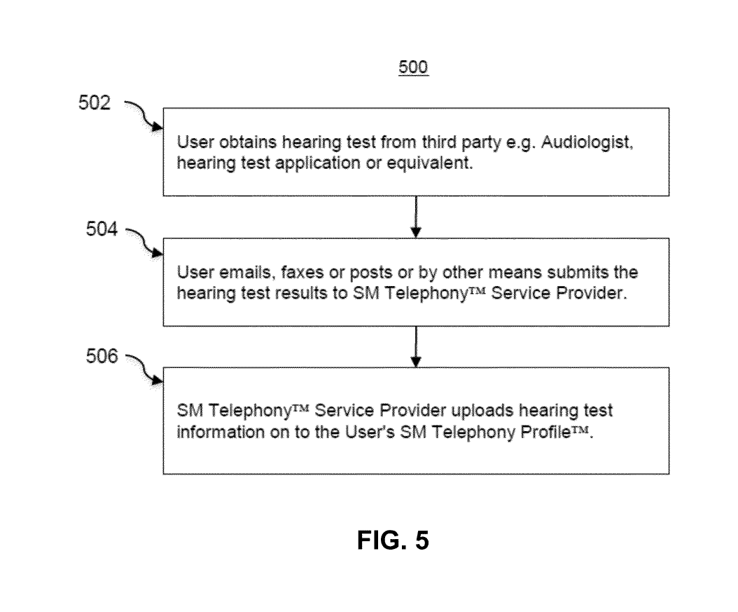

FIGS. 5 to 11 illustrate the processes used to set up and update the user's DSE Telephony Profiles and call management preferences.

FIG. 5 is a flow diagram that illustrates the DSE Telephony Profile Setup Method—Remote operation 500. In the first operation, indicated by box 502, a User is subjected to a hearing test, such as from third party, e.g. Audiologist, or the user may operate a hearing test application or equivalent. In the second operation, indicated by box 504, the User emails, faxes, mails, or posts or by other means submits the hearing test results to an DSE Telephony Service Provider. In the last operation, box 506, the DSE Telephony Service Provider uploads hearing test information on to the User's DSE Telephony Profile.

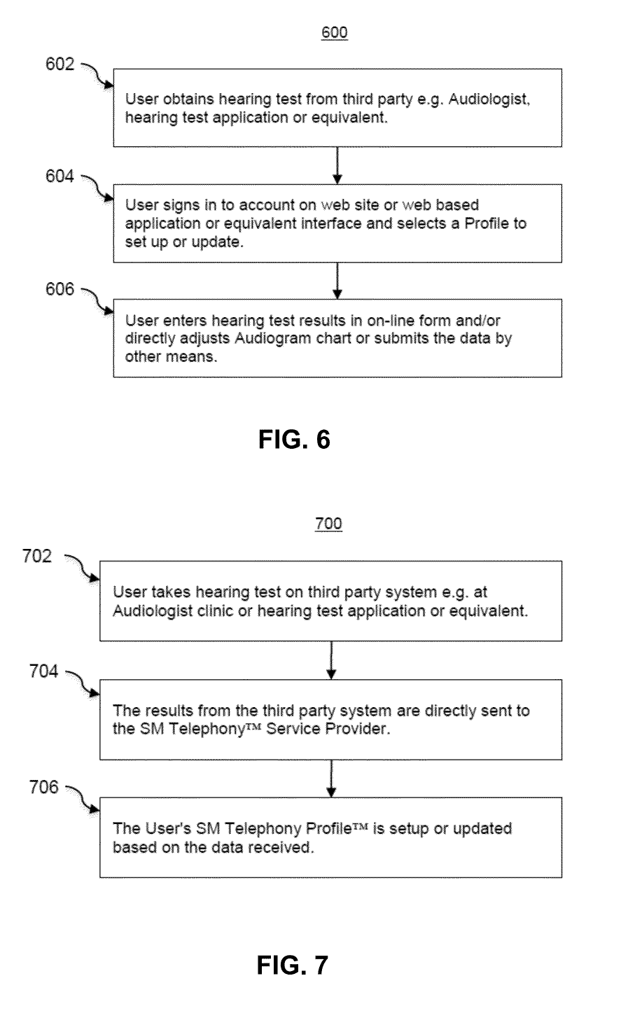

FIG. 6 is a flow diagram that illustrates the DSE Telephony Profile Setup Method—Online. In the first operation, corresponding to box 602, the User obtains a hearing test from a third party, e.g. an Audiologist, hearing test application, or equivalent. Next, at box 604, the User signs in to an account on a network, such as a Web site or a web-based application or equivalent interface, and selects a Profile to set up or to update. In the last operation, at box 606, the User enters the hearing test results in an on-line form and/or directly adjusts an Audiogram chart, or submits the data by other means.

FIG. 7 is a flow diagram that illustrates the DSE Telephony Profile Setup Method—Third Party System operation 700. The first operation, at box 702, the User takes hearing test on third party system e.g. at Audiologist clinic or hearing test application or equivalent. In the second operation, at box 704, the results from the third party system are directly sent to the DSE Telephony Service Provider. Lastly, at box 706, the User's DSE Telephony Profile is setup or updated based on the data received.

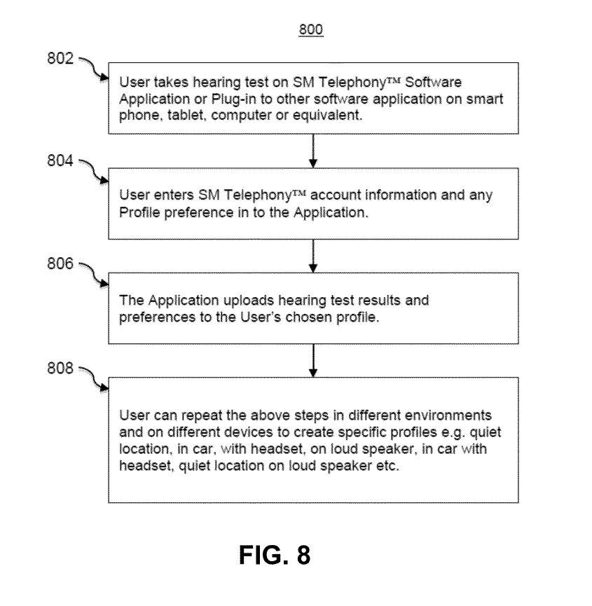

FIG. 8 is a flow diagram 800 that illustrates operation of the DSE Telephony Profile Setup Method—DSE Telephony Application Software. The first operation at box 802 comprises the User taking a hearing test on a DSE Telephony Software Application or Plug-in to other software application on smart phone, tablet, computer or equivalent. In the box 804 operation, the User enters DSE Telephony account information and any Profile preference in to the Application. At box 806, the Application uploads the hearing test results and preferences to the User's chosen profile. In the last operation, at box 808, the User can repeat the above steps in different environments and on different devices to create a specific profile for each different environment and/or device. For example, a different user profile may be created for a quiet location, in a car, with a headset, on a loudspeaker, in a car with a headset, at a quiet location on a loudspeaker, and so forth.

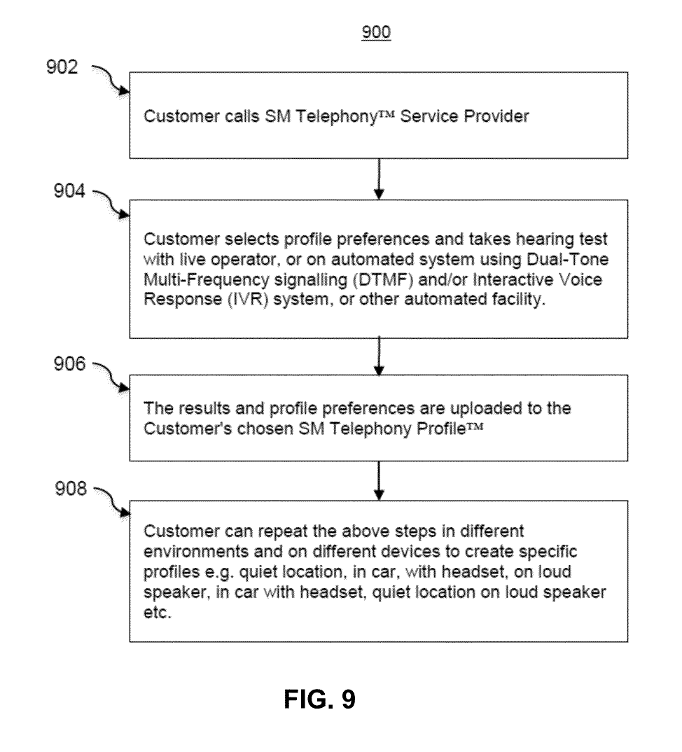

FIG. 9 is a flow diagram that illustrates the DSE Telephony Profile Setup Method—Telephone operation 900. In the first operation, at box 902, a Customer calls a DSE Telephony Service Provider. In the next step, at box 904, the Customer selects profile preferences and takes a hearing test with a live operator, or on an automated system using Dual-Tone Multi-Frequency signalling (DTMF) and/or Interactive Voice Response (IVR) system, or using another automated facility. At box 906, the results and profile preferences are uploaded to the Customer's chosen DSE Telephony Profile. Lastly, at box 908, the Customer can repeat the above steps in different environments and on different devices to create specific profiles, e.g., at a quiet location, in a car, with a headset, on a loudspeaker, in a car with a headset, at a quiet location on a loudspeaker, and so forth.

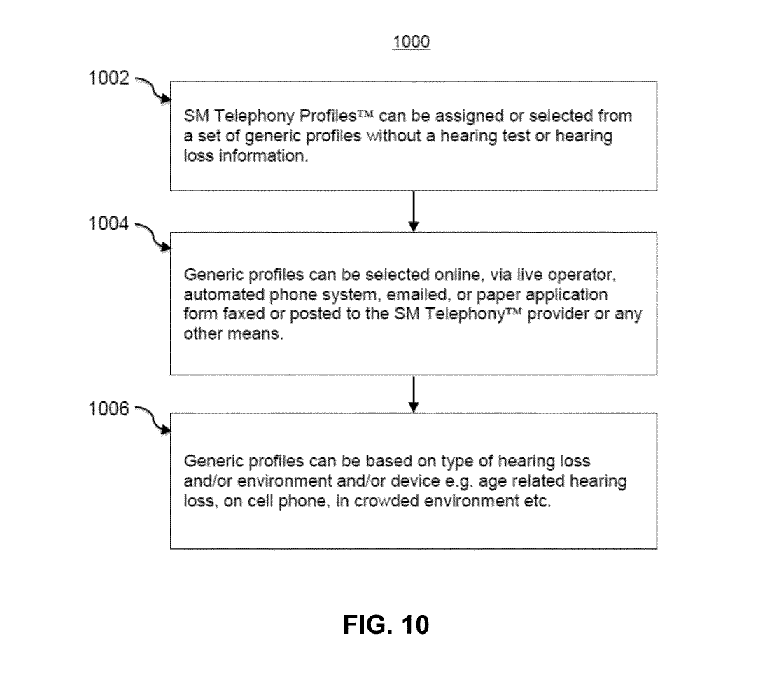

FIG. 10 is a flow diagram that illustrates the DSE Telephony Profile Setup Method—Generic Profiles operation 1000. For the first operation at box 1002, DSE Telephony Profiles can be assigned or selected from a set of generic profiles without a hearing test or hearing loss information. At box 1004, Generic profiles can be selected online, via live operator, automated phone system, emailed, or paper application form faxed or posted to the DSE Telephony provider, or any other means. Lastly, at box 1006, Generic profiles can be based on type of hearing loss and/or environment and/or device e.g. age related hearing loss, on cell phone, in crowded environment, and so forth.

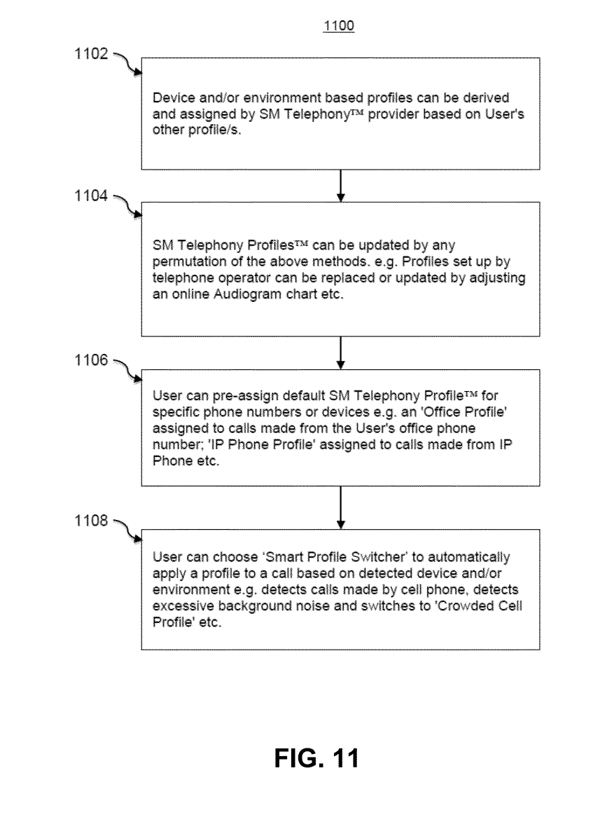

FIG. 11 is a flow diagram that illustrates the DSE Telephony Profile Setup Method—Updates and Misc operation 1100. In the first operation, at box 1102, Device and/or environment based profiles can be derived and assigned by DSE Telephony provider based on User's other profile/s. In the second operation, at box 1104, DSE Telephony Profiles can be updated by any permutation of the above methods. For example, Profiles set up by a telephone operator can be replaced or updated by adjusting an online Audiogram chart. Other suitable techniques will occur to those skilled in the art. At box 1106, the User can pre-assign a default DSE Telephony Profile for specific phone numbers or devices e.g. an “Office Profile” assigned to calls made from the User's office phone number; an “IP Phone Profile” assigned to calls made from an IP Phone, and so forth. Lastly, at box 1108, the User can choose a “Smart Profile Switcher” to automatically apply a profile to a call based on a detected device and/or sound characteristics, e.g. detects calls made by cell phone, detects excessive background noise, and switches to “Crowded Cell Profile”, and so forth.

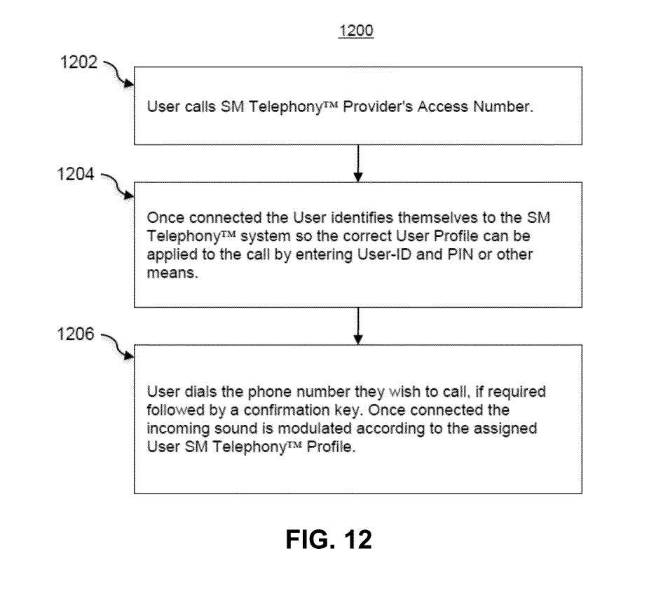

FIGS. 12 to 19 illustrate the processes used to make, receive and manage DSE Telephony calls.

FIG. 12 is a flow diagram that illustrates the DSE Telephony Making Calls—From any telephone with User ID and PIN. In the first operation at box 1202, the User calls the DSE Telephony Provider's Access Number. At box 1204, once connected, the User identifies themselves to the DSE Telephony system so the correct User Profile can be applied to the call by entering User-ID and PIN or other means. In the last operation at box 1206, the User dials the phone number they wish to call, if required followed by a confirmation key. Once connected the incoming sound is manipulated according to the assigned User DSE Telephony Profile.

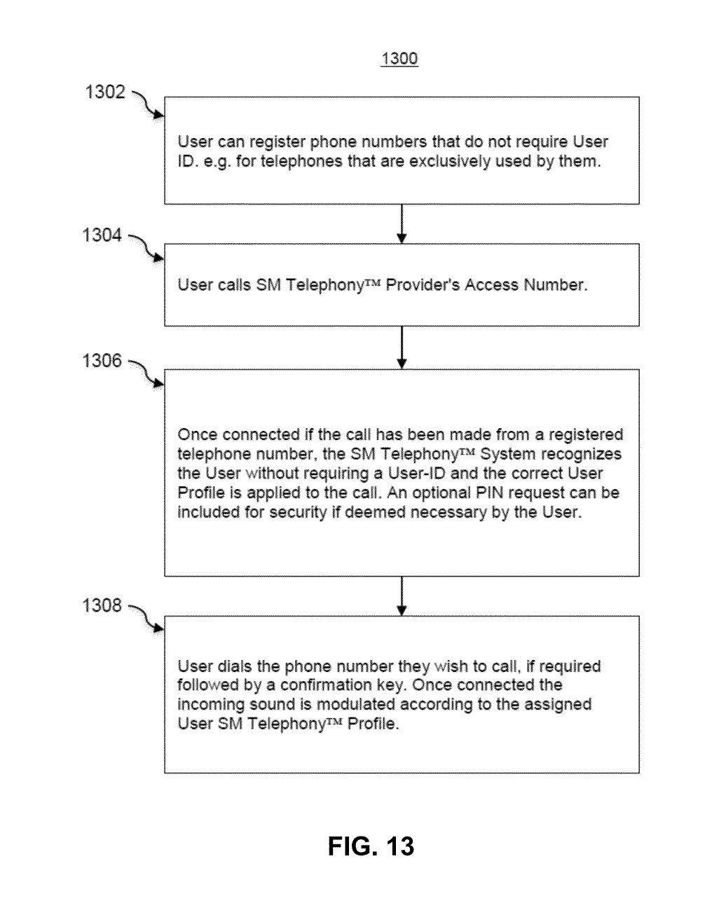

FIG. 13 is a flow diagram that illustrates the of DSE Telephony Making Calls—From registered phone numbers without User ID operation. The first operation is at box 1302, where the User can register phone numbers that do not require User ID. e.g. for telephones that are exclusively used by them. Next, at box 1304, the User calls the DSE Telephony Provider's Access Number. At box 1306, once connected, if the call has been made from a registered telephone number, the DSE Telephony System recognizes the User without requiring a User-ID and the correct User Profile is applied to the call. An optional PIN request can be included for security if deemed necessary by the User. At box 1308, the User dials the phone number they wish to call, if required followed by a confirmation key. Once connected, the incoming sound is manipulated according to the assigned User DSE Telephony Profile.

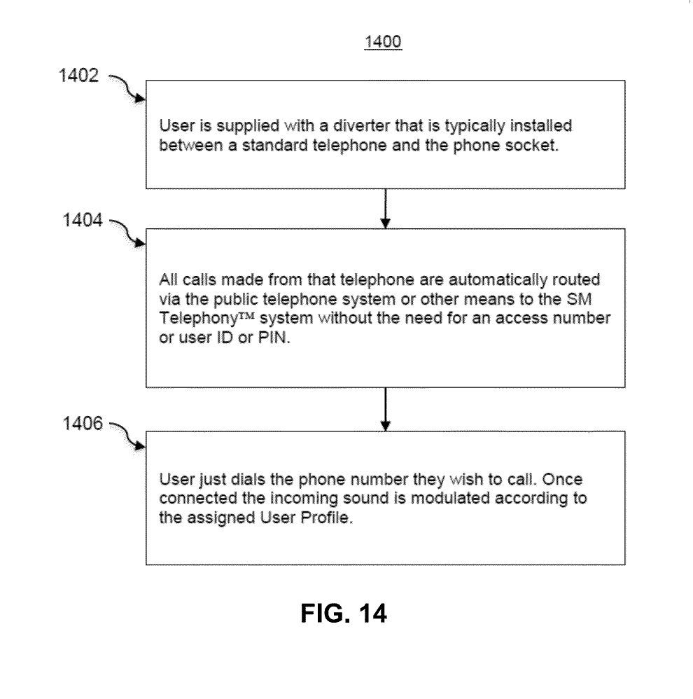

FIG. 14 is a flow diagram that illustrates the DSE Telephony Making Calls—With plug-in call diverter without access number operation. The first operation, at box 1402, is when a User is supplied with a diverter that is typically installed between a standard telephone and the phone socket. At box 1404, all calls made from that telephone are automatically routed via the public telephone system or other means to the DSE Telephony system without the need for an access number or user ID or PIN. Lastly, at box 1406, the User just dials the phone number they wish to call. Once connected the incoming sound is manipulated according to the assigned User Profile.

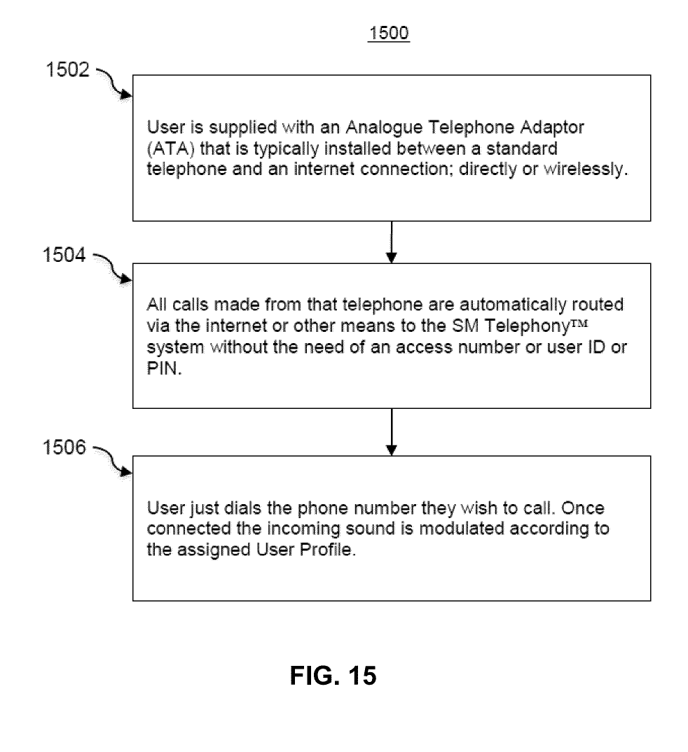

FIG. 15 is a flow diagram that illustrates DSE Telephony Making Calls—With Analog Telephone Adaptor operation. The first operation at 1502 is when a User is supplied with an Analogue Telephone Adaptor (ATA) that is typically installed between a standard telephone and an internet connection; directly or wirelessly. Next, at box 1504, not all calls made from that telephone are automatically routed via the internet or other means to the DSE Telephony system without the need of an access number or user ID or PIN. At box 1506, the User just dials the phone number they wish to call. Once connected, the incoming sound is manipulated according to the assigned User Profile.

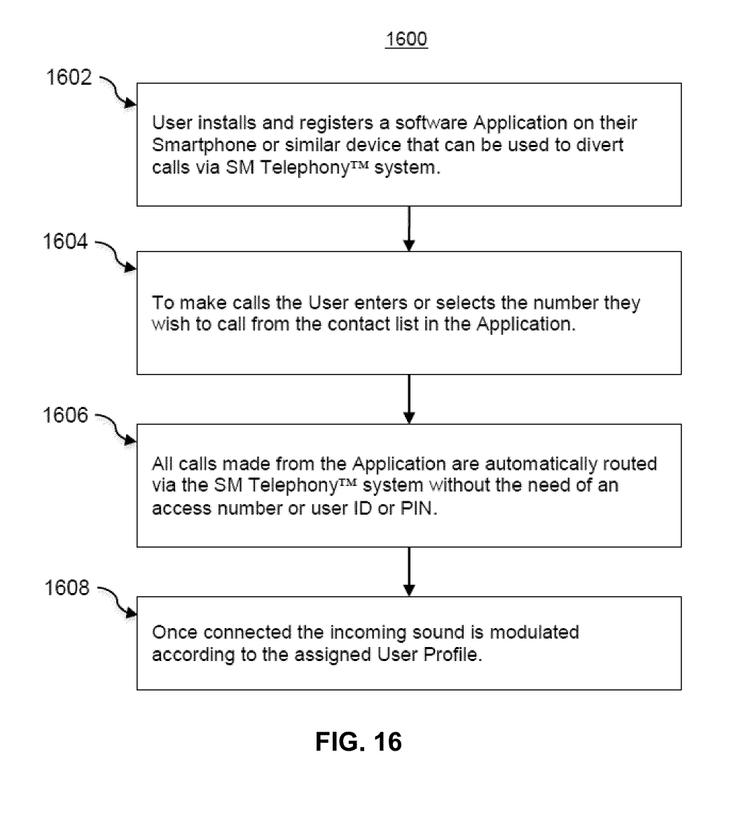

FIG. 16 is a flow diagram that illustrates the DSE Telephony Making Calls—From smartphone with Dialer App without access number operation. At box 1602, the User installs and registers a software Application on their Smartphone or similar device that can be used to divert calls via the DSE Telephony system. Next, at box 1604, to make calls, the User enters or selects the number they wish to call from the contact list in the Application. At 1606, all calls made from the Application are automatically routed via the DSE Telephony system without the need of an access number or user ID or PIN. At 1608, once connected, the incoming sound is manipulated according to the assigned User Profile.

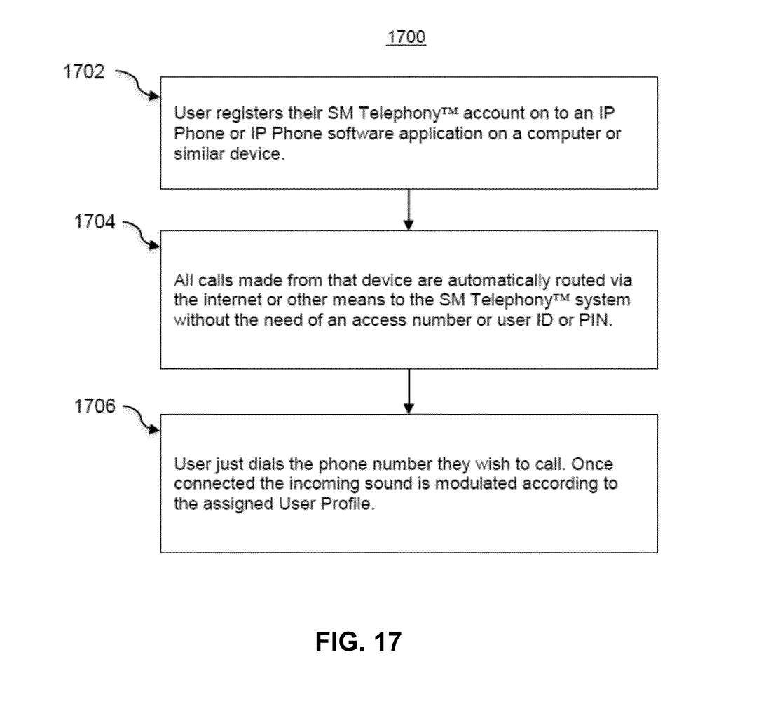

FIG. 17 is a flow diagram that illustrates the DSE Telephony Making Calls—From IP Phone or IP Phone Software operation. In the first operation, at box 1702, the User registers their DSE Telephony account on to an IP Phone or IP Phone software application on a computer or similar device. At box 1704, all calls made from that device are automatically routed via the internet or other means to the DSE Telephony system without the need of an access number or user ID or PIN. In the last operation, at box 1706, the User just dials the phone number they wish to call. Once connected, the incoming sound is manipulated according to the assigned User Profile.

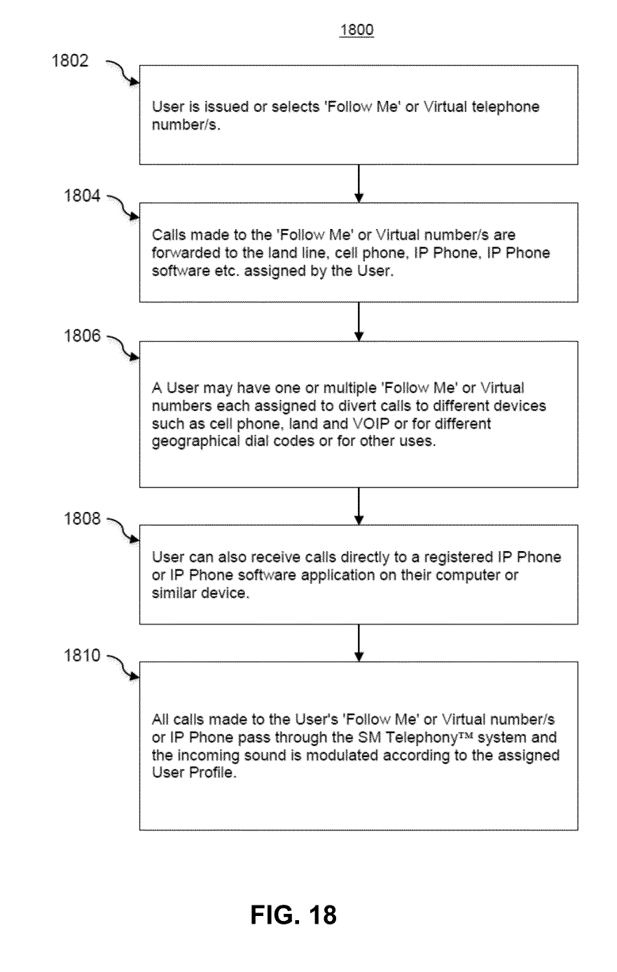

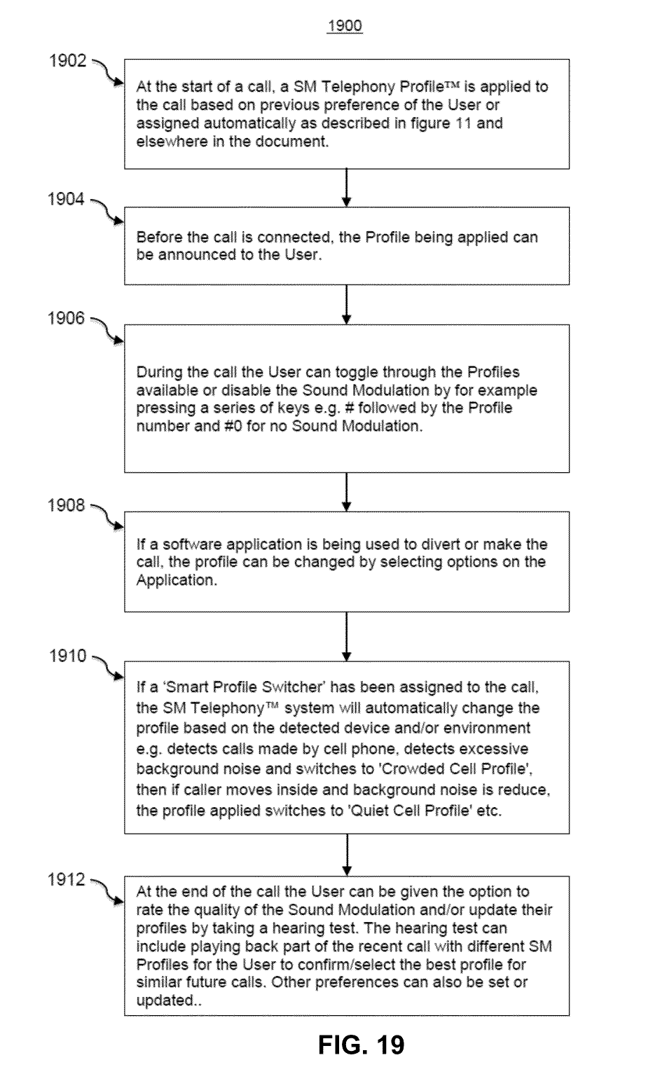

FIG. 18 is a flow diagram that illustrates the DSE Telephony Receiving Calls—Using ‘Follow me’ or Virtual number or IP Phone operation. The first operation is at box 1802, where the User is issued or selects Follow Me or Virtual telephone number/s. Next, at box 1804, calls made to the Follow Me or Virtual number/s are forwarded to the land line, cell phone, IP Phone, IP Phone software, and so forth, assigned by the User. At box 1806, a User may have one or multiple Follow Me or Virtual numbers each assigned to divert calls to different devices such as cell phone, land, and VOIP, or for different geographical dial codes or for other uses. Next, at box 1808, the User can also receive calls directly to a registered IP Phone or IP Phone software application on their computer or similar device. Lastly, at box 1810, all calls made to the User's Follow Me or Virtual number/s or IP Phone pass through the DSE Telephony system and the incoming sound is manipulated according to the assigned User Profile.

FIG. 19 is a flow diagram that illustrates the DSE Telephony During Call operation. In the first operation, at box 1902, at the start of a call, a DSE Telephony Profile is applied to the call based on previous preference of the User or assigned automatically as described in FIG. 11 and elsewhere in the document. At box 1904, before the call is connected, the Profile being applied can be announced to the User. Box 1906 shows that, during the call, the User can toggle through the Profiles available or disable the Speech enhancement by for example pressing a series of keys e.g. #* followed by the Profile number and #*0 for no Speech enhancement. At box 1908, if a software application is being used to divert or make the call, the profile can be changed by selecting options on the Application. At box 1910, if a Smart Profile Switcher has been assigned to the call, the DSE Telephony system will automatically change the profile based on the detected device and/or sound characteristics e.g. detects calls made by cell phone, detects excessive background noise and switches to a Crowded Cell Profile, then if caller moves inside and background noise is reduce, the profile applied switches to a Quiet Cell Profile, and so forth. Lastly, at box 1912, at the end of the call the User can be given the option to rate the quality of the speech enhancement and/or update their profiles by taking a hearing test. The hearing test can include playing back part of the recent call with different DSE Profiles for the User to confirm/select the best profile for similar future calls. Other preferences can also be set or updated.

Further Distinctions

Most sound signal processing is indiscriminate; Only Hearing Aid signal processing is bespoke to an individual; but it is not bespoke to type of sound nor environment of listener; none are developed dynamically from usage data.

Devices transmitting or reproducing sound signals frequently include sound filters or codecs to reduce cost of data transmission and storage, or improve sound quality. The algorithms for these sound filters are fixed and they are applied indiscriminately to all the sound signals being processed in the same way, regardless of the listener or characteristics of the sound being processed.

Hearing aids and assistive devices manipulate the audio signal to improve the sound quality, but to parameters set according to the hearing loss profile of a specific user. These parameters are typically set during fitting of the hearing aid. The algorithms and settings are limited by the compromise of attempting to be most effective on typical types of sound to be processed, in the most common environments users will find themselves in. This makes the signal processing in these devices less effective in many less common environments.

The algorithm for hearing aids are developed from a ‘systems’ perspective based on anatomy and physiology of the human hearing system and the nature of the impairment, then validated with a small group of listeners in a laboratory environment under synthetic control conditions usually with limited standardized pre-recorded background noises and sound files.

What's New

Existing Sound Signal Processing and Dynamic Speech Enhancement (DSE)

Sound signal processing is common in telecom and electronic devises, but only bespoke sound processing to a listener profile available in Hearing Aids. DSE can provide bespoke sound signal manipulation, to provide speech enhancement in telecom and electronic devices and software applications, not just hearing aids.

Even sound signal processing that is bespoke to individual listener i.e. in hearing aids, is not bespoke to characteristics of sound or environment of the listener. DSE can provide sound signal manipulation, to provide speech enhancement also bespoke to any characteristics of sound being processed (e.g. noisy signal, language being spoken, speed of speaker etc.), and any environment of the listener (e.g. car, busy office etc.)

Sound signal processing algorithms used in hearing aids are optimized and fixed for the hearing aid device receiving and reproducing the corrected sound for the user. DSE algorithms can be customized to provide speech enhancement for any combination of devices receiving, transmitting and reproducing the sound for the user. (e.g. different phones, carrier, headphone, speaker, etc.)

Sound signal processing parameters once set, do not change in response to changes to the user's condition or environment, nor characteristics of sound being processed. DSE algorithm and settings can be changed automatically or manually to be more effective for the characteristics of sound being processed or the user's environment or condition (e.g. tired).

The algorithms for typical sound signal processing are developed from a system perspective and tested to confirm effectiveness. DSE algorithms are developed and improved from a data perspective, incorporating machine-learning systems to continually improve and respond to observed changes.

Hearing aids are wearable instruments that typically fit in or behind the wearer's ear. ‘Raw’ sound is delivered to the hearing aid via a microphone on the instrument or wirelessly e.g. via Bluetooth, and only then it the sound signal processed by the electronics within the hearing aid. The parameters of the signal processing algorithms are pre-set during fitting according the hearing loss profile of the wearer. If the wearer is not happy with the sound correction, they typically have to return to the medical professional to alter the pre-set parameters of the signal processing algorithms used by the hearing aid.

The invention described includes a machine for and method of manipulating sound data before it is transmitted from a sound producing device. The method comprising: receiving the sound data at a signal processing computer processor; producing manipulated speech signal; settings to the signal processing algorithm based on applying the user hearing loss profile to the received sound data; providing the manipulated sound output to the user from the sound producing device.

This method of manipulating the sound before it leaves a sound producing device allows the user to listen to the enhanced speech without the use of a conventional hearing aid.

The invention described includes a machine for and method of processing sound data before it is transmitted from a sound producing device. The method comprising: receiving the sound data at a signal processing computer processor; producing manipulated speech signal; settings to the signal processing algorithm based on applying the user hearing loss profile to the received sound data; providing the manipulated sound output to the user from the sound producing device.

This method of manipulating the sound before it leaves a sound producing device allows the user to listen to the enhanced speech sound without the use of a conventional hearing aid.

Dynamic Speech Enhancement (DSE) System

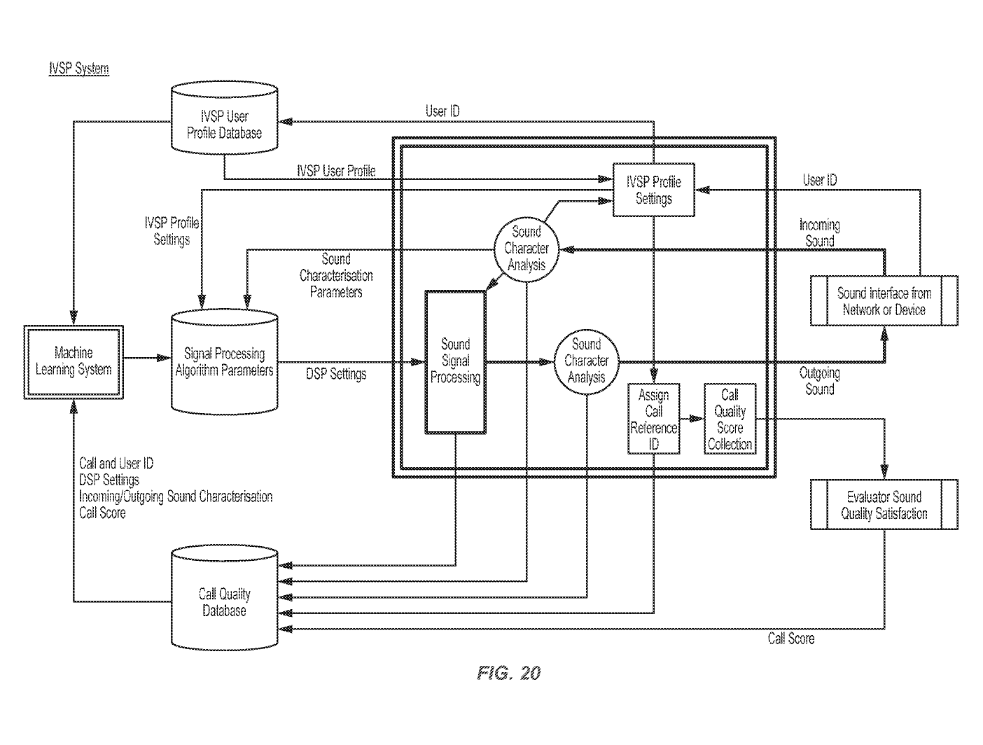

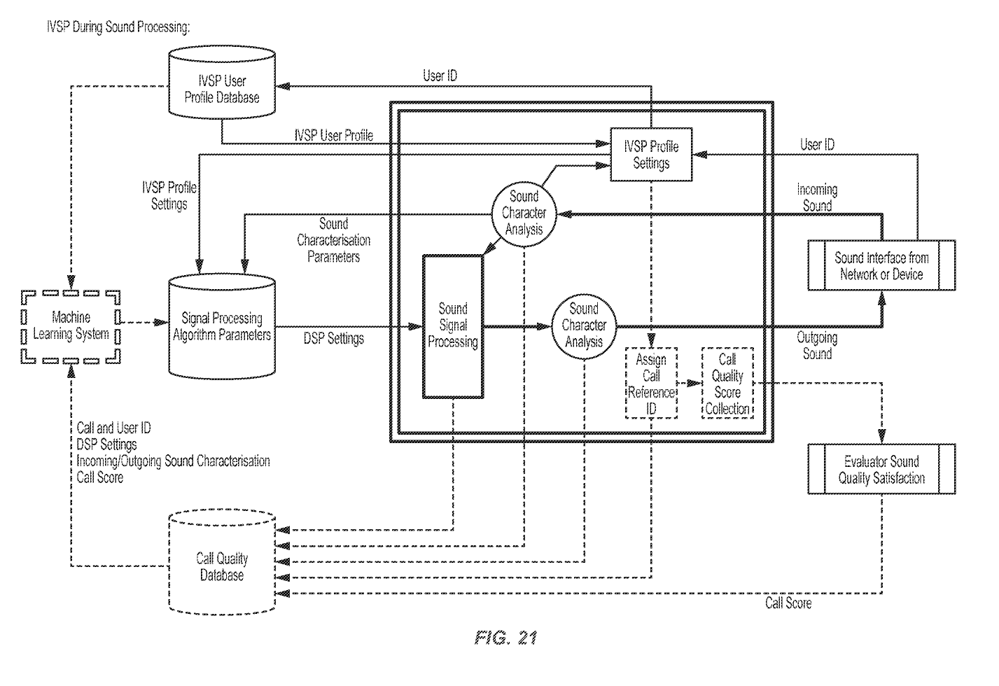

FIG. 20 is a block diagram that illustrates an embodiment of the DSE system described herein. The system includes the elements of: 1. Audio Interface Module; 2. Dynamic Speech Enhancement Processing Module; 3. Machine Learning System Processing Module; 4. Speech Enhancement Quality Scoring Interface Module; 5. User DSE Database; 6. Audio Signal Manipulation Algorithm Parameter Lookup Database; 7. Speech Enhancement Event Log Database.

FIG. 21 is a block diagram that illustrates operation of the FIG. 20 system during sound processing, such as during a telephone call or other communication. During a call, the incoming audio signal passes to (2) DSE Processing Module via (1) Audio Interface Module, as well as User ID reference. Both from the Network or Device (e.g. telephone PBX). In (2), the incoming sound is sampled to evaluate Audio Signal Characteristics, then the Audio Signal is manipulated to Enhance Speech intelligibility. The enhanced audio signal is sampled to evaluate Audio Signal Characteristics before being transmitted back to (1) the Audio Interface Module and on to the listener. The Parameters for Audio Signal Manipulation are derived from User Hearing Loss Profile, looked up from (5) based on the User ID, from Audio Characterization Parameters In Dynamic Mode/Or in Manual Mode from User Hearing Enhancement Profile Setting from (5) based on the User ID, and/or from Latest Sound Manipulation Algorithm Settings (updated by (3) as needed).

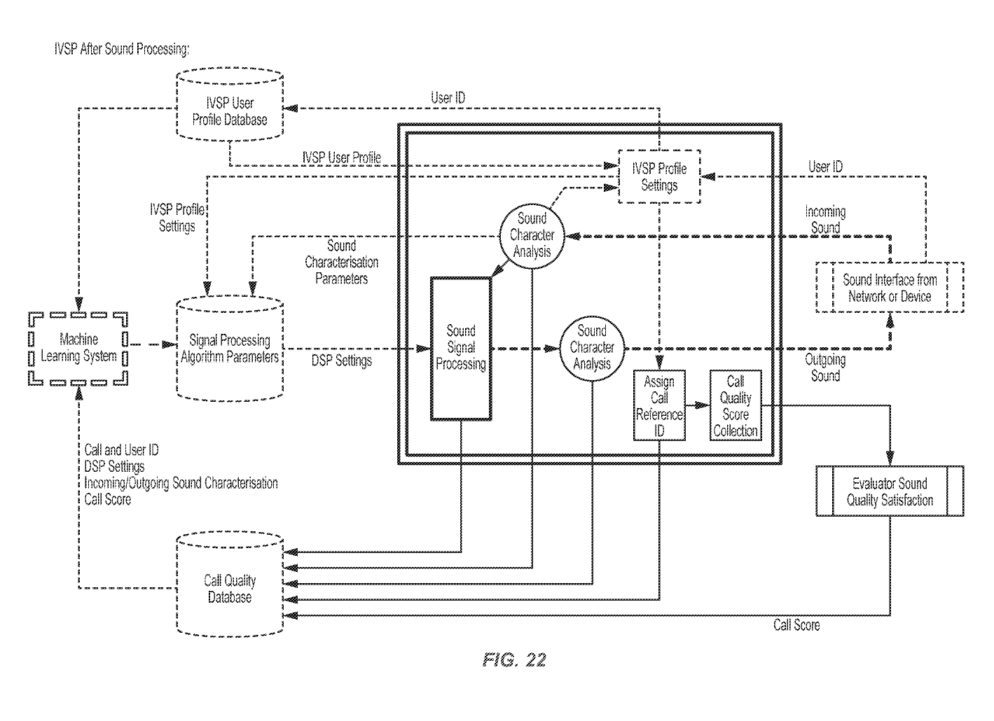

FIG. 22 is a block diagram that illustrates operation of the FIG. 20 system after completion of sound processing. After call completion, a unique event record ID is generated, typically by combining the User ID and the event date and time. For this unique event, Audio Characterization of the incoming and manipulated audio signal, and the Audio Signal Manipulation Settings are logged in (7). Incoming Audio characterization would be indicative of the quality of the incoming Audio, quantity and type of noise, language, speed of speech etc. Outgoing Audio characterization would be used for automated intelligibility scoring for each event, a request is sent to the user via (4), which could be an application that sends out an automated SMS to request a rating score from the User. When received, this score is added to the event log for this event.

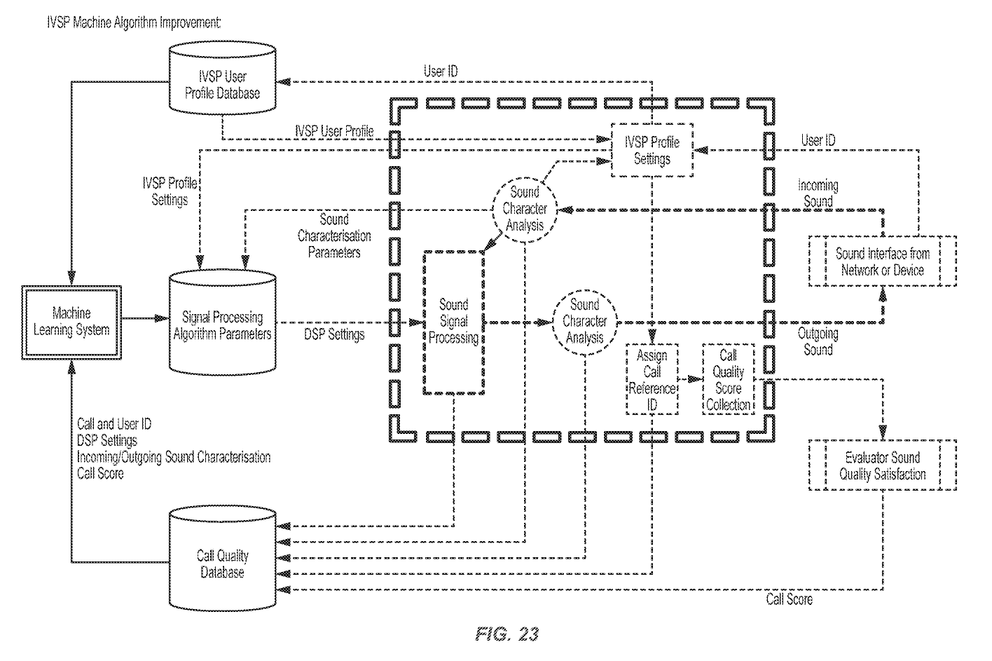

FIG. 23 is a block diagram that illustrates improved sound processing features provided by the FIG. 20 system. Features may include, for example, machine-learning techniques. A Machine Learning System Processing Module (3), analyses the event logs in (7) and the User Hearing Loss Profile from (5) to build algorithms to improve Speech Enhancement for other users. For example, if many people with similar hearing loss profiles and devices, and for a given incoming Sound Characteristic, consistently score an applied set of Signal Manipulation Parameters highly, this will become the default parameters that will be applied from (6) dynamically for all similar scenarios. A User Quality Score from (4) is used to calibrate and improve the Automated Intelligibility scoring based on the Outgoing Audio characterization. So that less frequent user scoring is needed and eventually done very infrequently.

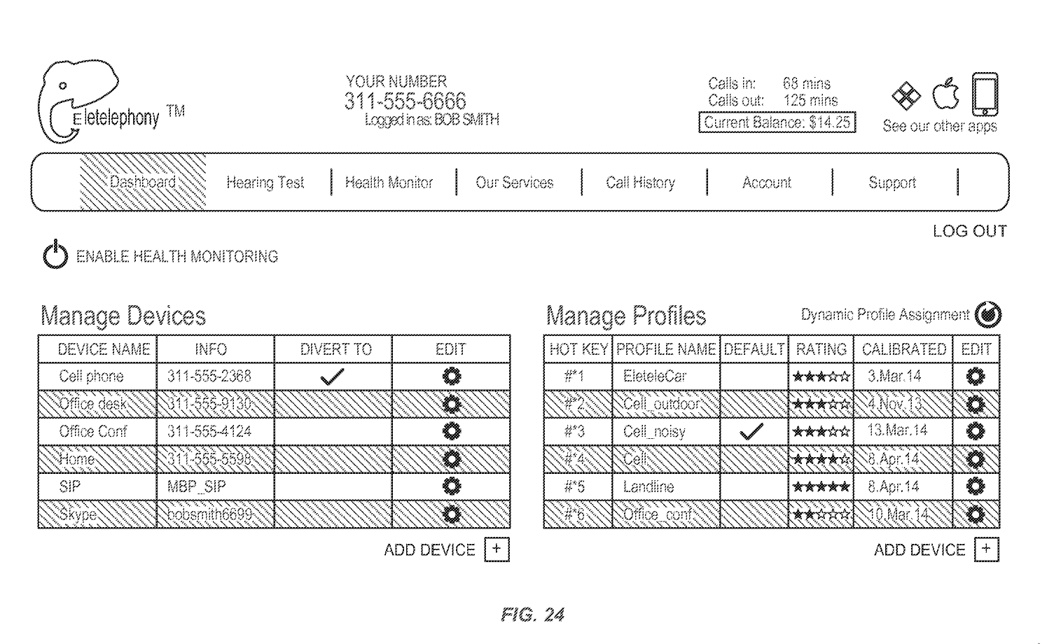

FIG. 24 is a dashboard design according to one embodiment.

Although the description above is provided in the context of telephony, it should be understood that the features described above could be applied in other embodiments such as consumer electronics, mobile sound devices, and sound reproduction devices generally. Such other embodiments may be implemented in sound devices such as mobile music players, televisions, mobile computing devices, and the like, such that the respective devices are capable of manipulating the sound data before the sound data leaves the device, enabling listening by a user without aid of a hearing assistance device, in the absence of which the user would be unable to hear the sound data as intelligibly. In such situations, the sound collection component (first sound device) of FIG. 2 would correspond to a sound source, such as pre-recorded music tracks, and the second sound device would correspond to a loudspeaker or other audio output of the second sound device. That is, the user would be enabled to listen to output of the second sound device, comprising the manipulated sound data, without aid of a hearing assistance device, in the absence of which the user would be unable to hear the sound data intelligibly.

DSE in Telephony

Described herein is an “Dynamic Speech Enhancement Telephony” (DSE Telephony), in which raw sound data is diverted via a telephony network comprising an exchange or the Internet to a DSE System for the sound data to be manipulated according to the user's profile. The manipulated sound is then diverted back through the telephony network to be received by any standard telephone, VOIP phone, computer interface, or other telephony device, already enhanced to the hearing profile selected by or for the user.

Receiving DSE Telephony calls is typically provided via a “follow me” or Virtual phone number service to deliver the DSE Telephony calls to any standard telephone equipment, VOIP interface or other telephony device being used to receive the call.

Making DSE Telephony calls is typically provided from any standard telephone or VOIP interface or other telephony device via an access number to divert the call via the DSE Telephony system to be processed. As an alternative to access numbers plug-in switches or software applications can be used to automatically route all calls via the DSE Telephony system.

Alternatively users can have all their calls through the DSE Telephony system. To have all their cell phone calls they get a new SIM and number or port their number, for all their land line calls, they transfer their account to us and get a new number or port their number.

The service offers setting up of ‘DSE Profiles’ that can be set up for different situations and types of equipment being used: e.g. profiles for: cell phone, land line, conference call, quiet location, busy location, cell phone in busy location, land line in quite location etc.

DSE Profiles can be automatically applied depending on the phone number being used or called or other data such as the ‘sound characteristics’ of the voice call. Alternatively Profiles can be manually switched on/toggled during the call, or turned off completely.

DSE Profiles can be created from third party Hearing Tests sent or uploaded to the service, or created via software applications on smart-phones or computers or other devices; or via manual or automated hearing test carried out over the phone; or selected from set of standard profiles, or by other means.

The DSE System evaluates the ‘characteristics’ of the incoming and outgoing sound signals to select the parameters for the Audio Signal Manipulation Algorithms. Parameters will be set based on the User's DSE profile, the devices being used, and the characteristic of incoming sound to be processed i.e. level and type of background noise, language being spoken, gender and age of the speaker etc.

The effectiveness of the DSE system to produce more intelligible and comfortable corrected signal will be monitored by evaluating the ‘characteristics’ of the outgoing sound signals, and/or by feedback and scoring by the user or other human listeners.

The effectiveness of the corrected sound signal, evaluated in this way, informs the machine learning systems of the DSE system to continuously improve the algorithms for setting the parameters for the Audio Signal Manipulation Module.

For clarity the following descriptions are not limited to telephone calls between a DSE user and a non-user i.e. one way speech enhancement; but the method is equally applicable for DSE to DSE telephony, or multiple DSE users in a conference call, or any other permutation thereof.

### Other Embodiments

1. DSE Telephony as TSP Service:

In this embodiment, DSE Telephony is provided as an integrated service directly by any type of telecommunications service provider (TSP). The speech enhancement is carried out within the TSP system instead of being diverted to an external DSE Telephony Service. The DSE service would be chosen by users similar to other services provided by the TSP like voicemail, call waiting etc. Other aspects of the service would function similar to the main embodiment of this invention, described herein.

2. Local DSE Telephony System:

In this embodiment, the DSE Telephony System can be installed locally within a private branch exchange (PBX) or other local networks to provide Speech enhancement for specific extensions or nodes. Other aspects of the service would function similar to the main embodiment of this invention, described herein.

3. DSE Telephone Handset Adaptor:

Electronic device designed to be deployed in-line between a telephone handset or headset or similar device, and a telephone; typically using standard telephone jack plugs. The device will manipulate the Raw Sound data from the telephone and transmit the Manipulated Sound data to the handset loudspeakers to provide speech enhancement according to the user's DSE Profile. DSE Telephone Handset Adaptors can be programmed by connection to computer or wirelessly or via the telephone network.

4. Layered Speech Enhancement:

This embodiment of the invention can be applied to the other embodiments, particularly when the sound producing device could be used by others. With ‘Layered Speech enhancement’, the Raw and Manipulated Sound are integrated and transmitted simultaneously. The resulting sound produced can be intelligible for the hearing impaired listener and seem less distorted to other listeners.

5. Speech enhancement Software Application or Plugin Software:

In this embodiment, the Speech enhancement is provided in DSE Software Applications or a Plugin to other Software Applications or the Operating System on a smartphone or computer or other sound producing device like television, radio, personal music player etc. providing Manipulated Sound data to the loudspeaker or headset of the device. Speech enhancement systems can also be incorporated in other systems such as industrial equipment, aircrafts for crew communications etc.

6. DSE Headphone Adaptor:

Electronic device designed to be deployed in-line between a headphone and sound producing devices like personal music players, typically using standard jack plugs. The device will manipulate the Raw Sound data from the sound producing device and transmit the Manipulated Sound data to the headphone speakers to Speech Enhancement according to the user's preferred profile.

7. DSE Telephony not for Hearing Impairment Benefit

This embodiment of the invention can be incorporated with the other embodiments, and provides for the Speech enhancement system to be used to provide benefits other than correcting hearing impairment for the listener. An example of this embodiment would be to manipulate the sound to correct speech impediments, clarify accents or for any other purpose.

8. Speech Enhancement of Broadcasted Events

This embodiment allows for a user to ‘dial in’ and listen to content from a third party on their standard telephone or other device and hear Speech Enhanced audio according to their chosen profile without a hearing aid. Similarly for listening to streaming or recorded content using smartphone, tablet, computer or other device, from a web page, cloud based software application, or connecting with a software application on the device. This service could be used for Conferences, Stadiums, TV and Radio broadcasts, or other use.

9. DSE Sound Characteristics for Other Benefits

The sound characteristics of the voice signal measured can also be used for monitoring the health or mood of the speaker, or conditions associated with Dysphonia such as Parkinsonism, or for voice authentication.

10. Improved Algorithm Development for Hearing Aids and Cochlear Implants

11. DSE in Classroom Product

The embodiments discussed herein are illustrative of one or more examples of embodiments of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the scope of the present invention. Hence, the present descriptions and drawings should not be considered in a limiting sense, as it is understood that the present invention is in no way limited to only the embodiments illustrated

What is claimed is:

1. A method of processing sound data, the method comprising:
identifying a User Speech Enhancement Profile of a user to whom the sound data is intended for listening;
manipulating the sound data according to parameters from the identified user speech enhancement profile at a speech enhancement computer processor and producing a corresponding manipulated sound output;
providing the manipulated sound output to the user.

2. The method as in claim 1, wherein processing the sound data comprises retrieving the identified user speech enhancement profile from computer data storage based on identification data of the user.

3. The method as in claim 1, wherein the sound data manipulation occurs before the sound data is received or is stored on a sound producing device.

4. The method as in claim 1, wherein the sound data manipulation occurs before the sound data is reproduced on a sound producing device.

5. The method as in claim 1, wherein the sound data manipulation occurs to improve intelligibility and/or overall perceptual quality for the listener.

6. The method as in claim 1, wherein the sound manipulation parameters are adjusted based on the measured characteristics of the sound data to be manipulated.

7. The method as in claim 1, wherein the sound manipulation parameters are adjusted based on the devices receiving, transmitting or reproducing the sound for the listener.

8. The method as in claim 1, wherein the sound manipulation parameters are adjusted based on the situation or environment the listener.

9. The method as in claim 1, wherein the algorithms and parameters for sound modulation is improved based on Speech Enhancement quality scoring using a machine-learning procedure.

10. A system comprising:
computer data storage that contains at least one User Speech Enhancement Profile for processing of sound data;
a speech enhancement computer processor configured to identify a User Speech Enhancement Profile of a user to whom the sound data is intended for listening, manipulate the sound data with the identified user speech enhancement profile, and produce a corresponding manipulated sound output for providing to the user.

11. The system as in claim 10, wherein the speech enhancement computer processor is further configured to retrieve the identified user speech enhancement profile from the computer data storage based on identification data of the user.

12. The system as in claim 10, wherein the sound data manipulation occurs before the sound data is received or is stored on a sound producing device.

13. The system as in claim 10, wherein the sound data manipulation occurs before the sound data is reproduced on a sound producing device.

14. The system as in claim 10, wherein the sound data manipulation occurs to improve intelligibility and/or overall perceptual quality for the listener.

15. The system as in claim 10, wherein the sound manipulation parameters are adjusted based on the measured characteristics of the sound data to be manipulated.

16. The system as in claim 10, wherein the sound manipulation parameters are adjusted based on the devices receiving, transmitting or reproducing the sound for the listener.

17. The system as in claim 10, wherein the sound manipulation parameters are adjusted based on the situation or environment the listener.

18. The system as in claim 10, wherein the algorithms and parameters for sound modulation is improved based on Speech Enhancement quality scoring using a machine-learning procedure.
